(19) United States
(12) Patent Application Publication
(10) Pub. No.: US 2017/0132538 A1
(43) Pub. Date: May 11, 2017

(54) PLANT MODEL CREATING DEVICE, PLANT MODEL CREATING METHOD, AND NON-TRANSITORY COMPUTER READABLE STORAGE MEDIUM

(71) Applicant: YOKOGAWA ELECTRIC CORPORATION, Tokyo (JP)

(72) Inventors: Kenichi OHARA, Tokyo (JP); Ken'ichi KAMADA, Tokyo (JP); Jun AOKI, Tokyo (JP)

(73) Assignee: YOKOGAWA ELECTRIC CORPORATION, Tokyo (JP)

(21) Appl. No.: 15/339,046

(22) Filed: Oct. 31, 2016

(30) Foreign Application Priority Data
Nov. 5, 2015 (JP) 2015-217814

(51) Int. Cl. G06Q 10/06; G06F 17/50

(52) U.S. Cl. CPC G06Q 10/067; G06F 17/5004; G06F 2217/16

(57) ABSTRACT

A plant model creating device includes a cluster analyzer configured to divide operating data into clusters, a principal component list generator configured to calculate a principal component and a contribution rate for every cluster and generate a principal component list, a cumulative contribution rate calculator configured to calculate a cumulative contribution rate based on the principal component list, a principal component remover configured to remove, from the principal component list, a principal component corresponding to a contribution rate added to the cumulative contribution rate, if the cumulative contribution rate is less than a first threshold value, a characteristic formula calculator configured to calculate a characteristic formula whose normal vector is the principal component included in the principal component list, and a model creator configured to create a model of the plant based on the characteristic formula.

### BACKGROUND

Technical Fields

The disclosure relates to a plant model creating device, a plant model creating method, and a non-transitory computer readable storage medium.

Priority is claimed on Japanese Patent Application No. 2015-217814, filed Nov. 5, 2015, the contents of which are incorporated herein by reference.

Related Art

An operation plan creating system which creates an operation plan of a plant for realizing energy saving and cost saving is known (for example, Japanese Unexamined Patent Application Publication No. 2015-62102). The operation plan created by the operation plan creating system includes start/stop of equipment in the plant and a time series trend of input/output values. Therefore, in order to create an operation plan which can save energy and cost of the entire plant, it is necessary to create a model of the plant based on input/output characteristics of equipment and operation restrictions.

However, in order to create a model of the plant, special knowledge, such as knowledge of physics/thermodynamics/chemical-engineering about equipment, knowledge of data-analysis/statistics, knowledge of optimization problems (for example, mathematical programming), and knowledge of programming, is needed. For this reason, quality of the model of the plant is greatly dependent on the knowledge level of an engineer who creates the model.

Especially, it is necessary to comprehensively define characteristic formulas and restriction conditions related to equipment in order to create the model of the plant more precisely. However, even if the engineer has a high knowledge level, it is difficult to define characteristic formulas and restriction conditions with respect to equipment.

In recent years, in order to save energy of a plant, “supply-demand bidirectional cooperation” for suppressing use of fossil fuel by reusing, as fuel, by-products discharged by production process is performed. For this reason, since the model of the plant is increased in size and complicated, there is a case that a large number of man-hours are required for creating the model.

### SUMMARY

A plant model creating device may include an outlier remover configured to remove outliers from operating data of a plant, a cluster analyzer configured to divide, into clusters, the operating data from which the outliers have been removed by the outlier remover, a principal component list generator configured to calculate a principal component and a contribution rate for every cluster divided by the cluster analyzer, the principal component list generator being configured to generate a principal component list including the principal component and the contribution rate, a cumulative contribution rate calculator configured to calculate a cumulative contribution rate based on the principal component list generated by the principal component list generator, a principal component remover configured to remove, from the principal component list, a principal component corresponding to a contribution rate added to the cumulative contribution rate, if the cumulative contribution rate calculated by the cumulative contribution rate calculator is less than a first threshold value, a characteristic formula calculator configured to calculate a characteristic formula whose normal vector is the principal component included in the principal component list, and a model creator configured to create a model of the plant based on the characteristic formula calculated by the characteristic formula calculator.

Further features and aspects of the present disclosure will become apparent from the following detailed description of exemplary embodiments with reference to the attached drawings.

### BRIEF DESCRIPTION OF THE DRAWINGS

FIG. 1 is a block diagram illustrating a whole configuration of a system which includes an energy management system 1, a controlling/monitoring system 50, and a plant 60.

FIG. 2 is a block diagram illustrating a detail configuration of the operation plan creating system 10.

FIG. 3 is a block diagram illustrating a detail configuration of the plant model creating device 100.

FIG. 4 is a drawing illustrating an example of the operating data 181.

FIG. 5 is a drawing illustrating an example of the energy flow diagram 193.

FIG. 6 is a drawing illustrating an example of the χ-square distribution created by the outlier remover 131.

FIG. 7 is a drawing illustrating an example of the operating data 181 clustered by the cluster analyzer 132.

FIG. 8 is a drawing illustrating an example of a first principal component axis AX.

FIG. 9 is a drawing illustrating an example of the principal component list 183 with respect to a certain cluster.

FIG. 10 is a drawing illustrating an example of the plane P1.

FIG. 11 is a drawing illustrating an example of the plane P2.

FIG. 12 is a drawing illustrating an example of the piece wise linear approximate formula generated by the model creator 140.

FIG. 13 is a drawing illustrating an example of time series trend of input/output amount of equipment.

FIG. 14 is a drawing illustrating an example of Gantt chart of operation showing start/stop of equipment.

FIG. 15 is a drawing illustrating an example of a cost-saving merit.

FIG. 16 is a flow chart showing an operation plan creation processing executed by the operation plan creating system 10.

### DETAILED DESCRIPTION OF THE EMBODIMENTS

The embodiments of the present invention will be now described herein with reference to illustrative preferred embodiments. Those skilled in the art will recognize that many alternative preferred embodiments can be accomplished using the teaching of the present invention and that the present invention is not limited to the preferred embodiments illustrated herein for explanatory purposes.

An aspect of the present invention is to provide a plant model creating device, a plant model creating method, and a non-transitory computer readable storage medium which can comprehensively extract characteristic formulas and restriction conditions related to equipment based on operating data of a plant, and can accurately create a model of the plant by a small number of man-hours without special knowledge.

Hereinafter, a plant model creating device, a plant model creating method, and a non-transitory computer readable storage medium of embodiments will be described with reference to drawings.

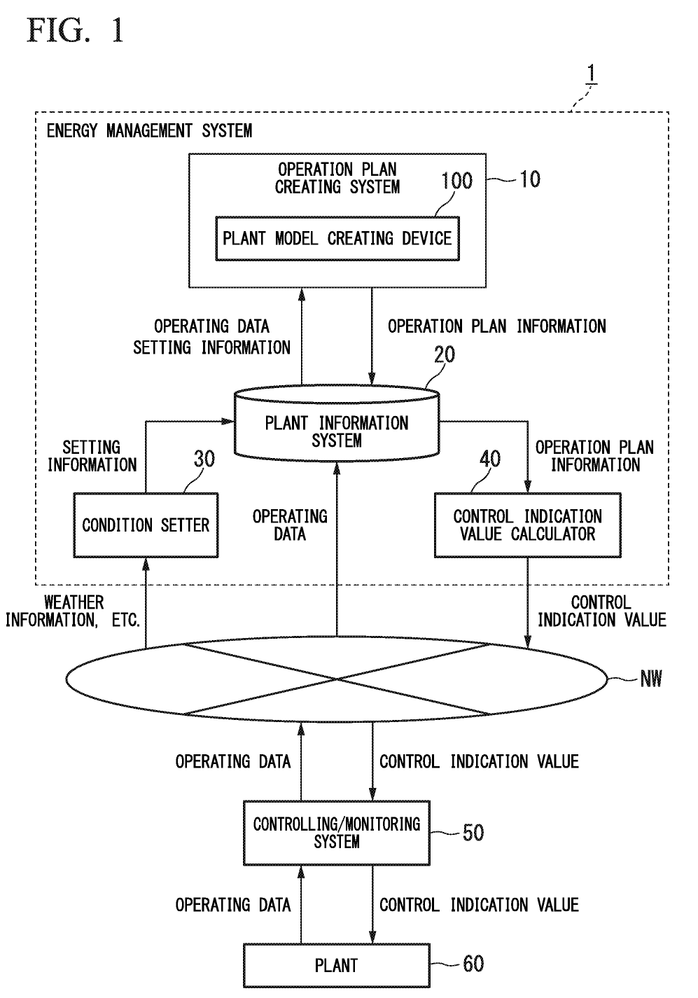

FIG. 1 is a block diagram illustrating a whole configuration of a system which includes an energy management system 1, a controlling/monitoring system 50, and a plant 60. As shown in FIG. 1, the energy management system 1 is connected to a network NW. Although the network NW is a wired network such as Ethernet (registered trademark), the network NW may be a wireless network which can perform wireless communication in conformity with wireless communication standards, such as Wi-Fi (registered trademark), WiMAX (registered trademark), 3G/LTE (registered trademark), and so on.

The energy management system 1 is equipped with an operation plan creating system 10, a plant information system 20, a condition setter 30, and a control indication value calculator 40. The operation plan creating system 10 is a system which creates an operation plan of the plant 60. The plant information system 20 is a system which manages information of the plant 60. The condition setter 30 is a device which sets various types of conditions about operation of the plant 60. The control indication value calculator 40 is a device which calculates a control indication value for controlling various types of equipment installed in the plant 60.

The controlling/monitoring system 50 is a system which monitors a control of the plant 60 and a state of the plant 60. The plant 60 includes an industrial plant such as a chemical industrial plant, a plant managing and controlling a wellhead (for example, a gas field and an oil field), a plant managing and controlling a generation of electric power (for example, hydro power, thermal power, and nuclear power), a plant managing and controlling a power harvesting (for example, solar power and wind power), a plant managing and controlling water supply and sewerage systems, a dam, and so on.

For example, the controlling/monitoring system 50 and the plant 60 are connected to a wired industrial network which is in conformity with HART (registered trademark), FieldBus, or the like, but not limited thereto. For example, the controlling/monitoring system 50 and the plant 60 may be connected to a wireless industrial network which is in conformity with ISA100.11a, WirelessHART (registered trademark), or the like.

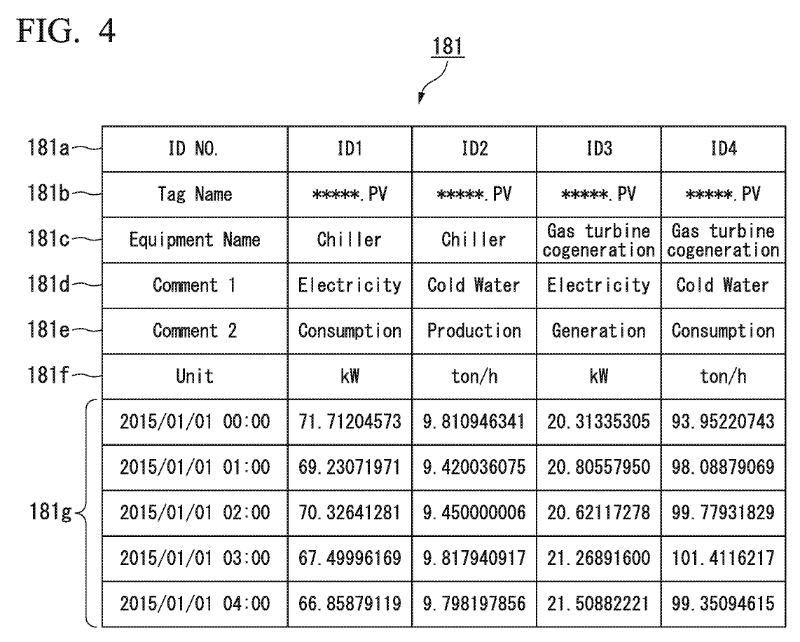

The plant 60 transmits, to the controlling/monitoring system 50, operating data of various types of equipment installed in the plant 60. Details of the operating data will be described later with reference to FIG. 4. The controlling/monitoring system 50 transmits the operating data, which has been received from the plant 60, to the plant information system 20 through the network NW.

On the other hand, the condition setter 30 receives weather information (temperature information, humidity information, and so on) from a server of a weather forecast distribution company (not illustrated) through the network NW. The condition setter 30 stores production-plan/energy-demand information, charge-unit-cost/CO₂ conversion coefficient, and so on. The condition setter 30 transmits, to the plant information system 20, the weather information, the production-plan/energy-demand information, the charge-unit-cost/CO₂ conversion coefficient, and so on, as setting information.

The plant information system 20 transmits, to the operation plan creating system 10, the operating data of the plant 60 received from the controlling/monitoring system 50 and the setting information (the weather information, the production-plan/energy-demand information, the charge-unit-cost/CO₂ conversion coefficient, and so on) received from the condition setter 30.

The operation plan creating system 10 is equipped with a plant model creating device 100. The plant model creating device 100 creates a model of the plant 60 by using the operating data of the plant 60 received from the plant information system 20. The operation plan creating system 10 generates operation plan information which represents an operation plan of the plant 60 based on the model created by the plant model creating device 100 and the setting information received from the plant information system 20. The operation plan creating system 10 transmits the generated operation plan information to the plant information system 20.

The plant information system 20 transmits, to the control indication value calculator 40, the operation plan information received from the operation plan creating system 10. The control indication value calculator 40 calculates a control indication value for controlling various types of equipment installed in the plant 60 based on the operation plan information received from the plant information system 20. The control indication value calculator 40 transmits the calculated control indication value to the controlling/monitoring system 50 through the network NW.

The controlling/monitoring system 50 controls various types of equipment installed in the plant 60 based on the control indication value received from the control indication value calculator 40. The plant 60 transmits operating data of the various types of equipment installed in the plant 60 to the controlling/monitoring system 50. The operation described above is a sequential operation of the whole system.

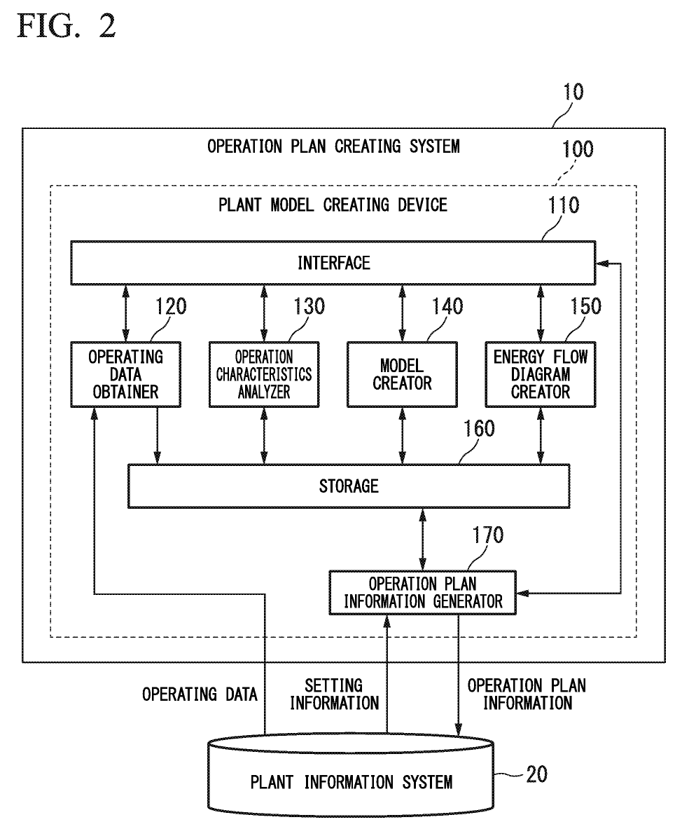

FIG. 2 is a block diagram illustrating a detail configuration of the operation plan creating system 10. The plant model creating device 100 prepared in the operation plan creating system 10 is equipped with an interface 110, an operating data obtainer 120, an operation characteristics analyzer 130, a model creator 140, an energy flow diagram creator 150, storage 160, and an operation plan information generator 170.

The interface 110 is a user interface which has a display device such as a liquid crystal display, and an input device such as a keyboard and a mouse. The interface 110 performs input/output of information with respect to the operating data obtainer 120, the operation characteristics analyzer 130, the model creator 140, and the energy flow diagram creator 150.

The operating data obtainer 120, the operation characteristics analyzer 130, the model creator 140, and the energy flow diagram creator 150 are implemented by a processor, such as CPU (Central Processing Unit), executing a program stored in the storage 160. The operating data obtainer 120, the operation characteristics analyzer 130, the model creator 140, and the energy flow diagram creator 150 may be implemented by hardware, such as an LSI (Large Scale Integration) and an ASIC (Application Specific Integrated Circuit), which has the same function as the processor executing the program.

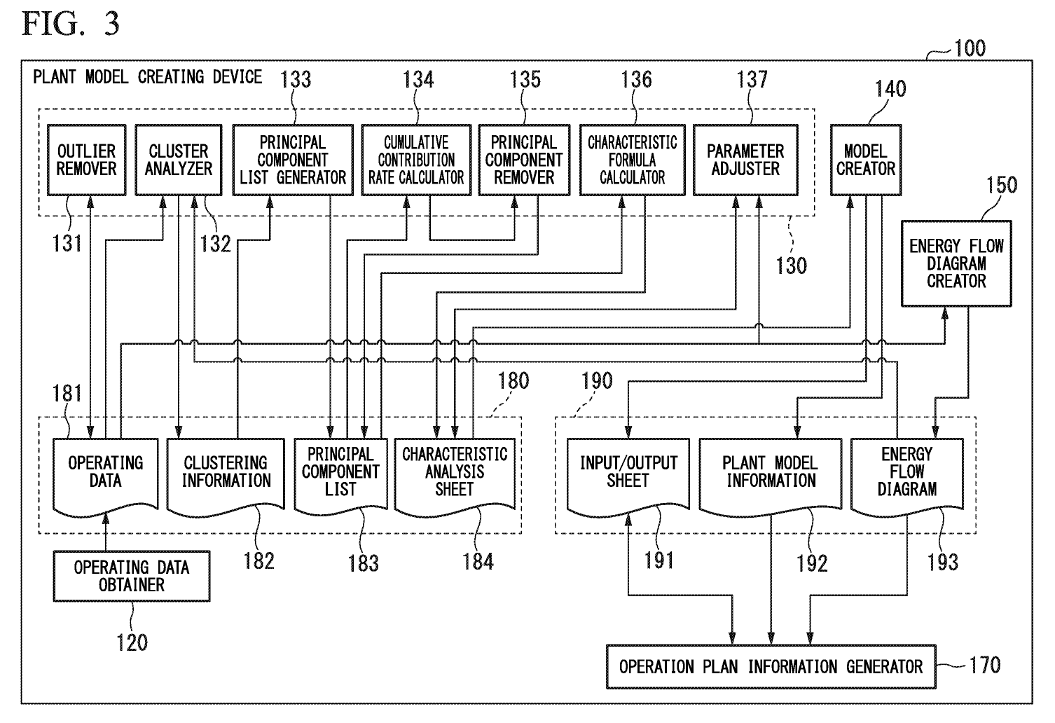

The operating data obtainer 120 obtains the operating data of the plant 60 from the plant information system 20. The operation characteristics analyzer 130 analyzes operation characteristics of equipment installed in the plant 60. The model creator 140 creates a model of the plant 60. The energy flow diagram creator 150 creates an energy flow diagram. Details of operation of the operating data obtainer 120, the operation characteristics analyzer 130, the model creator 140, and the energy flow diagram creator 150 will be described later with reference to FIG. 3.

The storage 160 is a memory used by the operating data obtainer 120, the operation characteristics analyzer 130, the model creator 140, the energy flow diagram creator 150, and the operation plan information generator 170. For example, the storage 160 may be implemented by a ROM (Read Only Memory), a RAM (Random Access Memory), a HDD (Hard Disk Drive), a flash memory, or the like.

The operation plan information generator 170 receives the setting information from the plant information system 20, and generates operation plan information with reference to the information stored in the storage 160. Details of a method of generating the operation plan information will be described later with reference to FIG. 3. The operation plan information generator 170 transmits the generated operation plan information to the plant information system 20.

FIG. 3 is a block diagram illustrating a detail configuration of the plant model creating device 100. The operation characteristics analyzer 130 is equipped with an outlier remover 131, a cluster analyzer 132, a principal component list generator 133, a cumulative contribution rate calculator 134, a principal component remover 135, a characteristic formula calculator 136, and a parameter adjuster 137.

A characteristic analysis component 180 and a plant model component 190 are information stored in the storage 160. The characteristic analysis component 180 includes an operating data 181 of the plant 60, a clustering information 182, a principal component list 183, and a characteristic analysis sheet 184. The plant model component 190 includes an input/output sheet 191, plant model information 192, and an energy flow diagram 193.

FIG. 4 is a drawing illustrating an example of the operating data 181. As shown in FIG. 4, the operating data 181 includes ID number data 181a, tag name data 181b, equipment name data 181c, comment data 181d and 181e, unit data 181f, and measurement data 181g.

In FIG. 4, the ID number data 181a represents an ID number allocated for each tag of the operating data 181 obtained from the plant information system 20. The tag name data 181b represents a tag name of the operating data which is a measurement target of equipment, and the tag name data 181b is stored in the plant information system 20. The equipment name data 181c represents a name of equipment installed in the plant 60. The comment data 181d represents a measurement target of equipment, such as electricity and cold water. The comment data 181e represents data related to the measurement target of equipment, such as consumption, production, and generation. The unit data 181f represents a unit of the measurement data 181g. The measurement data 181g represents data measured by equipment installed in the plant 60.

The operating data obtainer 120 stores, in the storage 160, the operating data 181 of the plant 60 obtained from the plant information system 20. The energy flow diagram creator 150 reads the operating data 181 of the plant 60 out of the storage 160, and creates the energy flow diagram 193 representing the customer's plant 60 by using the operating data 181 read out of the storage 160. Specifically, the energy flow diagram creator 150 creates the energy flow diagram 193 by using general graphic software (for example, Microsoft Visio (registered trademark)) based on instructions of a user from the interface 110.

As a stencil of the graphic software, nine basic object icons (for example, an equipment type object, a sauce/storage type object, a demand/balance type object, a sensor type object, an object for defining restriction condition, a link object between pages, a hierarchy type object, a connector for energy flow, and a connector for obtaining information) are registered beforehand. The energy flow diagram creator 150 creates the energy flow diagram 193 by using these basic object icons.

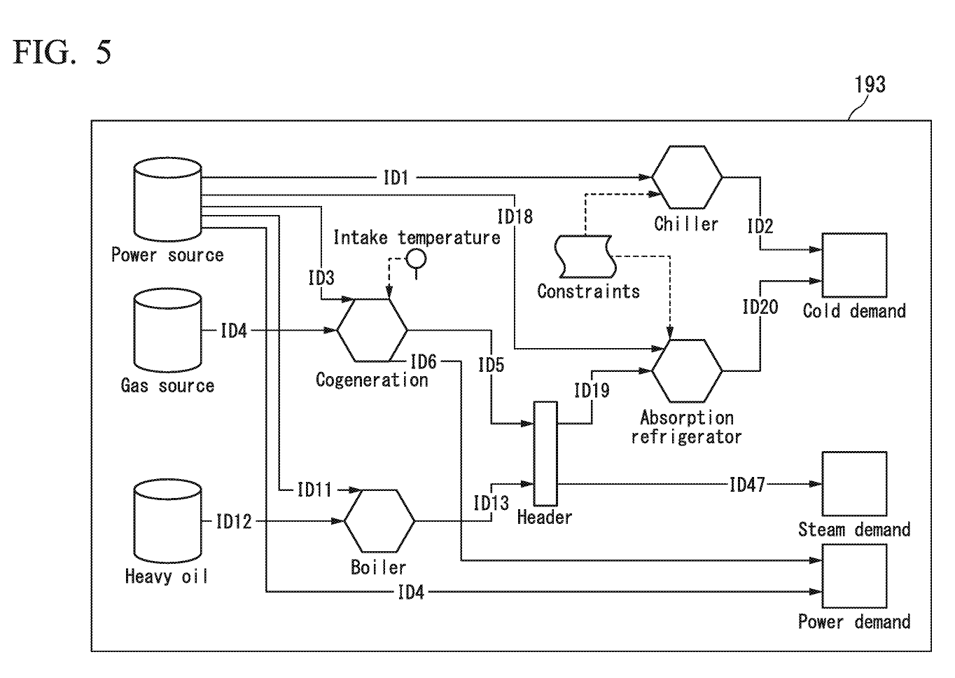

FIG. 5 is a drawing illustrating an example of the energy flow diagram 193. As shown in FIG. 5, the energy flow diagram 193 is a diagram illustrating a plurality of equipment of the plant 60 connected by the connector for energy flow.

In the energy flow diagram 193, objects such as a boiler and a chiller are arranged. These objects are connected to each other by the connector for energy flow. An ID number of the operating data 181 is associated with the connector for energy flow. For example, the ID number of the operating data 181 can be associated with the connector for energy flow by dragging and dropping the ID number of the operating data 181 shown in FIG. 4 to the connector for energy flow. Thereby, the energy flow diagram creator 150 can create the energy flow diagram 193.

Next, if the user instructs an execution of “model creation” from the interface 110, creation processing of a plant model is started. In the creation processing of a plant model, in order to calculate an exact energy-saving potential it is necessary to create an accurate model of which error (model error) between the operating data 181 and a model value is small. However, if many outliers (or abnormal values) caused by a failure of a measurement device are included in the operating data 181, it is difficult to create the accurate model. For this reason, the outlier remover 131 removes outliers from the operating data 181 beforehand.

The outlier remover 131 reads the operating data 181 of the plant 60 out of the storage 160, and removes outliers from the operating data 181 by using Mahalanobis distance. Specifically, the outlier remover 131 converts multivariate operating data X into the Mahalanobis distance D, based on the formula 1 described below, by using an average value μ thereof and a variance-covariance matrix V.

D²(xᵢ)=(xᵢ−μ)^{T}V⁻¹(xᵢ−μ) [Formula 1]

Next, the outlier remover 131 calculates a probability density function P, based on the formula 2 described below, by using the Mahalanobis distance D, and creates a χ-square distribution.

$$P ( D ) = \{ \begin{matrix}\frac{{D}^{\frac{t}{2} - 1} \cdot {e}^{- \frac{D}{2}}}{{2}^{\frac{t}{2}} \cdot Γ ( \frac{t}{2} )} & … D \geq 0 \\ 0 & … D < 0\end{matrix} \qquad [ Formula 2 ]$$

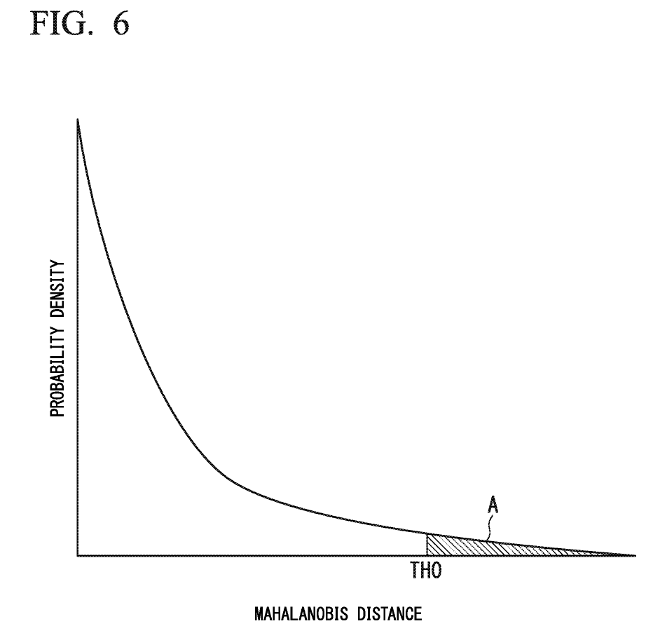

FIG. 6 is a drawing illustrating an example of the χ-square distribution created by the outlier remover 131. In FIG. 6, the horizontal axis shows the Mahalanobis distance D, and the vertical axis shows the probability density function P. The outlier remover 131 calculates, as a threshold TH0, a value corresponding to a ratio α (for example, 5%) of the area A of outliers to the area of the χ-square distribution. The outlier remover 131 checks the Mahalanobis distance of all the data, and removes the data (outliers) exceeding the threshold value TH0 from the operating data 181. Thereafter, the outlier remover 131 stores, into the storage 160, the operating data 181 from which the outliers have been removed.

The cluster analyzer 132 performs clustering of the operating data 181. Specifically, the cluster analyzer 132 reads, out of the storage 160, the operating data 181 from which the outliers have been removed. Moreover, the cluster analyzer 132 divides the operating data 181 into groups (clusters) each of which shows the same tendency and pattern by fitting based on a Gaussian Mixture Model.

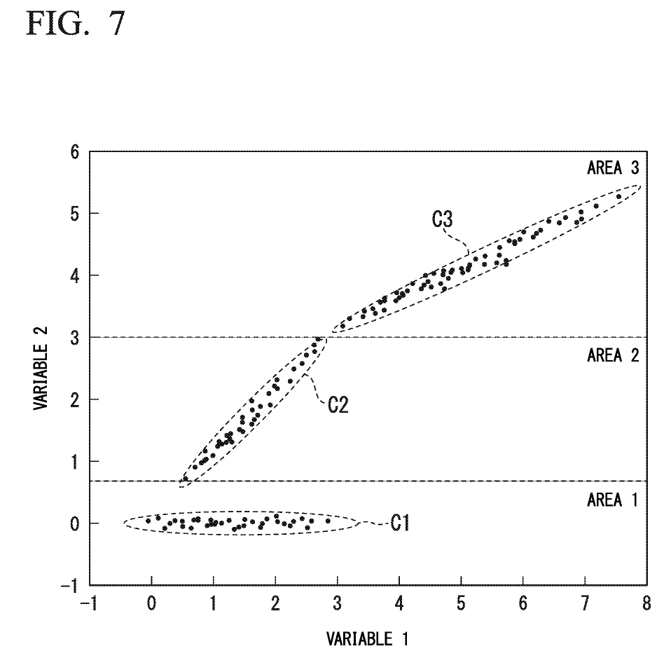

FIG. 7 is a drawing illustrating an example of the operating data 181 clustered by the cluster analyzer 132. In FIG. 7, the horizontal axis shows a variable 1 (for example, fuel amount) of the operating data 181, and the vertical axis shows a variable 2 (for example, power generation amount) of the operating data 181. In the example shown in FIG. 7, two variables are shown in order to understand easily, but the number of variables may be three or more.

The cluster analyzer 132 divides the operating data 181 until one cluster is classified to one area. The cluster analyzer 132 ends clustering when the division number reaches a maximum division number (for example, 10).

In the example shown in FIG. 7, the operating data 181 is divided into the three clusters C1 to C3, but not limited thereto. For example, the cluster analyzer 132 may divide the operating data 181 into four or more clusters. The cluster analyzer 132 stores the clusters C1 to C3, which have been divided from the operating data 181, into the storage 160 as the clustering information 182.

The principal component list generator 133 extracts a principal component based on the clustering information 182 generated by the cluster analyzer 132. Specifically, the principal component list generator 133 reads the operating data 181 and the clustering information 182 (clusters C1 to C3) out of the storage 160. Moreover, the principal component list generator 133 calculates a principal component of the cluster, which has been read out of the storage 160, by performing a Principal Component Analysis (PCA).

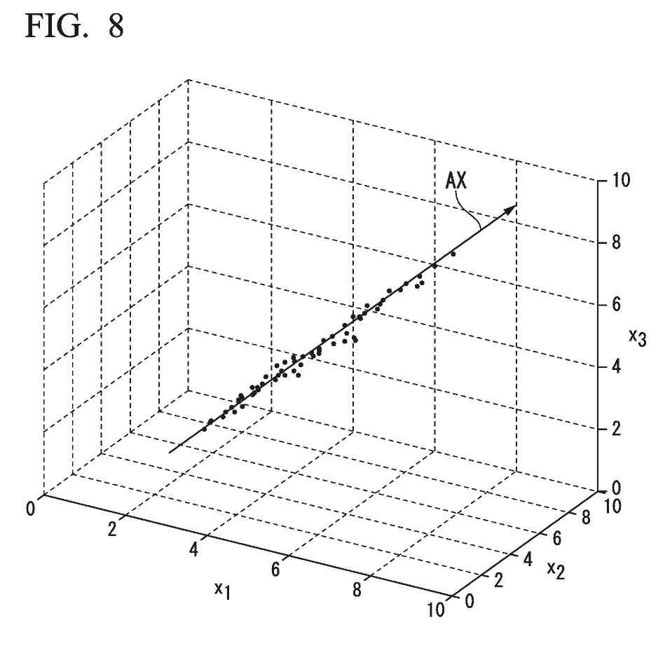

FIG. 8 is a drawing illustrating an example of a first principal component axis AX. In the example shown in FIG. 8, three axes corresponding to three variables x₁ to x₃ are shown in order to understand easily, but the number of variables may be four or more.

The principal component list generator 133 applies the Principal Component Analysis (PCA) with respect to data X′^{data} obtained by normalizing operating data X^{data}. The operating data X^{data} is shown as the formula 3 described below. Here, “n” represents a number of ID numbers (a number of variables) associated with the connector for energy flow, and “I” represents a number of clustered clusters.

X^{data}=[x₁^{data},x₂^{data}. . . ,xₙ^{data}]^{T}εR^{N×I} [Formula 3]

The principal component list generator 133 calculates a principal component C′_{N} (C′₁, C′₂, . . . , C′ₙ) which satisfactorily explains the operating data by applying the Principal Component Analysis (PCA) to the normalized data X′^{data}.

The principal components of n number calculated by the principal component list generator 133 are perpendicular to each other. The principal component list generator 133 calculates a contribution rate CR based on the formula 4 described below. The contribution rate CR is a value representing how much the principal component explains the operating data 181. Here, a eigenvalue λ is a value representing a dispersion of the principal component.

$$CR ( j ) = \frac{{λ}_{j}}{{\sum }_{i = 1}^{n} {λ}_{i}} = \frac{{λ}_{j}}{p} ∵ p = {\sum }_{i = 1}^{n} {λ}_{i} \qquad [ Formula 4 ]$$

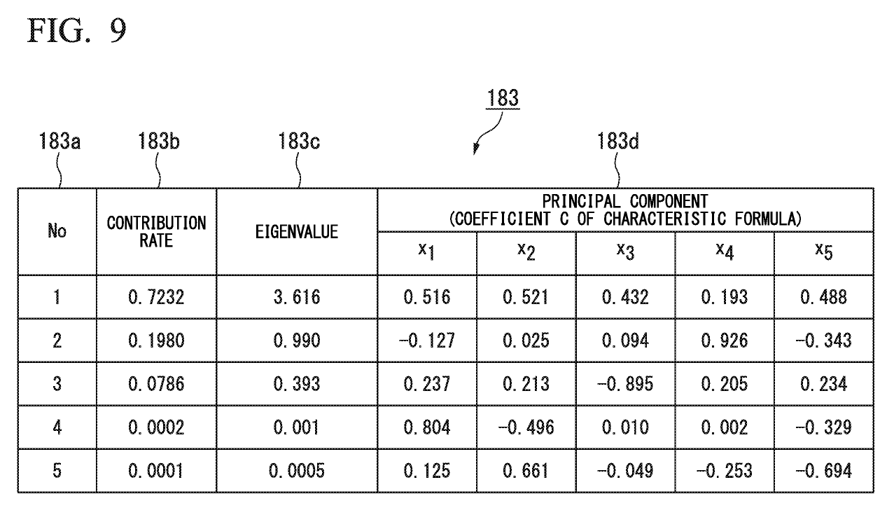

FIG. 9 is a drawing illustrating an example of the principal component list 183 with respect to a certain cluster. The principal component list 183 is a list including number data 183a of the principal component, contribution rate data 183b, eigenvalue data 183c, and principal component data 183d. The principal component list generator 133 extracts principal components in decreasing order of the contribution rate CR, and the principal component list generator 133 generates the principal component list 183. The principal component list generator 133 stores the generated principal component list 183 into the storage 160.

Next, the cumulative contribution rate calculator 134 reads the principal component list 183 out of the storage 160, and obtains the contribution rate CR in the principal component list 183. Thereafter, the cumulative contribution rate calculator 134 calculates a cumulative contribution rate CCR based on the formula 5 described below. The cumulative contribution rate calculator 134 outputs the calculated cumulative contribution rate CCR to the principal component remover 135.

$$CCR ( j ) = {\sum }_{i = 1}^{j} CR ( i ) = {\sum }_{i = 1}^{j} \frac{{λ}_{i}}{p} \qquad [ Formula 5 ]$$

The principal component remover 135 compares the cumulative contribution rate CCR calculated by the cumulative contribution rate calculator 134 with a first threshold value TH1 (for example, 0.95). The first threshold value TH1 is not limited to 0.95, and a suitable value may be set as the first threshold value TH1.

If the principal component remover 135 determines that the cumulative contribution rate CCR is less than the first threshold value TH1, the principal component remover 135 removes, from the principal component list 183, the principal component corresponding to the contribution rate CR added to the cumulative contribution rate CCR. The principal component remover 135 repeatedly performs this processing to remove principal components of which contribution rate CR is high. The principal component remover 135 stores, into the storage 160, the principal component list 183 in which a part of the principal components has been removed.

Hereinafter, an example of removal processing of principal component will be described. Five principal components are included in the principal component list 183 shown in FIG. 9. First, the cumulative contribution rate calculator 134 calculates a first cumulative contribution rate CCR (the contribution rate of the first principal component)=0.7232. Since the calculated first cumulative contribution rate CCR (0.7232) is less than the first threshold value TH1 (0.95), the principal component remover 135 removes the first principal component from the principal component list 183.

Next, the cumulative contribution rate calculator 134 calculates a second cumulative contribution rate CCR (the contribution rate of the first principal component+the contribution rate of the second principal component)=0.7232+0.1980=0.9212. Since the calculated second cumulative contribution rate CCR (0.9212) is less than the first threshold value TH1 (0.95), the principal component remover 135 removes the second principal component from the principal component list 183.

Next, the cumulative contribution rate calculator 134 calculates a third cumulative contribution rate CCR (the contribution rate of the first principal component+the contribution rate of the second principal component+the contribution rate of the third principal component)=0.7232+0.1980+0.0786=0.9998. Since the calculated third cumulative contribution rate CCR (0.9998) is more than the first threshold value TH1 (0.95), the principal component remover 135 stores, into the storage 160, the principal component list 183 in which the first principal component and the second principal component have been removed. Thereafter, characteristic formula calculation processing is performed by the characteristic formula calculator 136.

The characteristic formula calculator 136 reads the principal component list 183 out of the storage 160. The characteristic formula calculator 136 calculates, as a characteristic formula, an equation of a plane whose normal vector is a principal component C′_{K} (C′₁, C′₂, . . . , C′ₖ) of k number which remains in the principal component list 183. Here, the characteristic formula is shown as the formula 6 described below.

C′ₖ(X′_{N})=[c′_{k,1}·x′₁+c′_{k,2}·x′₂+ . . . +c′_{k,n}·x′ₙ=0]εR^{N×I} [Formula 6]

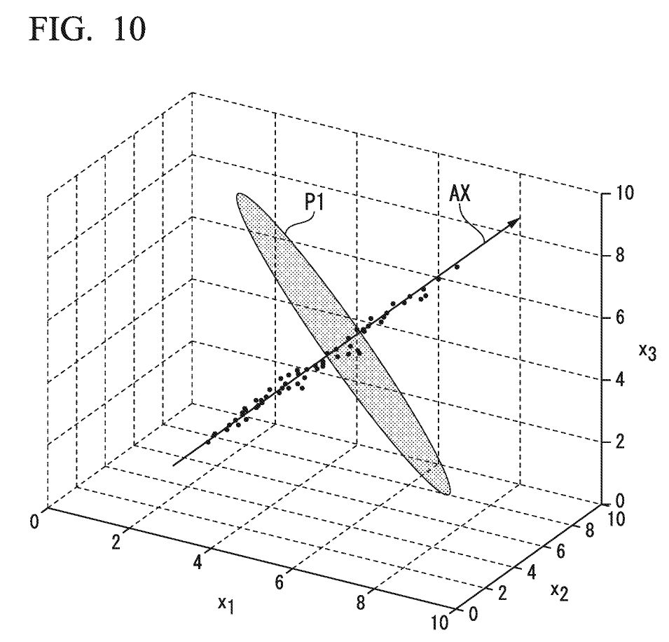

The principal component remover 135 removes an axis (for example, the first principal component axis AX) which satisfactorily explains the operating data 181 and whose contribution rate CR is high. This is because the operating data 181 is hardly included in the plane P1 which intersects perpendicularly with this principal component axis, as shown in FIG. 10.

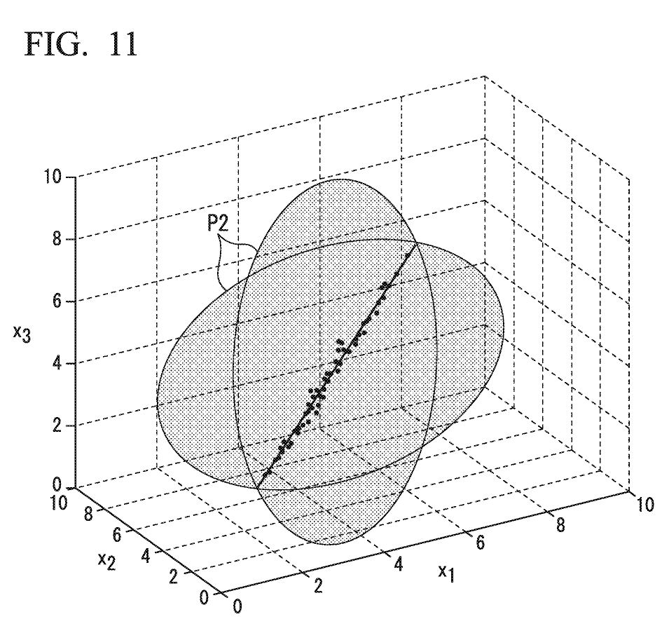

Therefore, as shown in FIG. 11, the characteristic formula calculator 136 can calculate the planes P2 including a lot of operating data 181 by using, as a normal vector, an axis of principal components which remain in the principal component list 183 and whose contribution rate CR is low.

The equations of the plane calculated by the characteristic formula calculator 136 are restriction condition formulas in which relation to each variable is represented by “=0”. For example, these formulas include a correlation formula between variables such as a balance of income and outgo, a relation formula whose physical characteristic is unknown, and so on, in addition to an input/output relation formula of equipment. For this reason, the characteristic formula calculator 136 can calculate comprehensively characteristic formulas related to equipment installed in the plant 60.

The calculated characteristic formulas are normalized. For this reason, the characteristic formula calculator 136 converts the calculated characteristic formula into a characteristic formula returned to real quantity before normalizing by using an average value m and a standard deviation s of the operating data 181, and the characteristic formula calculator 136 calculates a coefficient c and a bias b. Specifically, the characteristic formula calculator 136 performs the calculation shown in the formula 7 described below.

$${c}_{k , 1} ( {x}_{1} - {m}_{1} ) + {c}_{k , 2} ( {x}_{2} - {m}_{2} ) + … + {c}_{k , n} ( {x}_{n} - {m}_{n} ) = 0 ∵ {c}_{k} = \frac{{c}_{k}^{′}}{s} , \\ {x}^{′} = x - m ⇒ {c}_{k , 1} \cdot {x}_{1} + {c}_{k , 2} \cdot {x}_{2} + … + {c}_{k , n} \cdot {x}_{n} + {b}_{k} = 0 ∵ {b}_{k} = {\sum }_{n} - {c}_{k , n} \cdot {m}_{n} \qquad [ Formula 7 ]$$

If an error (model error) between an estimate value (model value) of the operating data calculated based on the characteristic formula and an actual measurement value of the operating data 181 is less than or equal to the second threshold value TH2 (for example, 1%), the operation characteristics analyzer 130 outputs the calculated characteristic formula to the characteristic analysis sheet 184, and ends the analysis. The characteristic analysis sheet 184 is a sheet generated by using general spreadsheet software (for example, Microsoft Excel (registered trademark)).

On the other hand, if the model error is greater than the second threshold TH2, the operation characteristics analyzer 130 increases an area division number of the operating data 181 divided by the cluster analyzer 132 from r to r+1, and the operation characteristics analyzer 130 calculates characteristic formulas again. The cluster analyzer 132 increases the area division number of the operating data 181 so that the model error can be decreased.

However, if a number of characteristic formulas calculated by increasing the area division number of clustering to r+1 is less than a number of characteristic formulas calculated when the area division number of clustering is r, it is considered that a characteristic, which had appeared, disappears because of subdividing data. For this reason, the operation characteristics analyzer 130 outputs, to the characteristic analysis sheet 184, a characteristic formula whose model error is minimum in the characteristic formulas obtained before and when the area division number of clustering is r, and ends the analysis. Similarly, if the area division number has reached a maximum value (for example, 10), the operation characteristics analyzer 130 outputs, to the characteristic analysis sheet 184, a characteristic formula whose model error is minimum in the characteristic formulas obtained before, and ends the analysis.

The parameter adjuster 137 adjusts parameters (for example, the coefficient c and the bias b) of the characteristic formula calculated by the characteristic formula calculator 136. For example, the parameter adjuster 137 reads, out of the storage 160, the operating data 181 in a period for calculating an energy-saving potential. Thereafter, the parameter adjuster 137 calculates the coefficient c and the bias b by using the operating data 181 read out of the storage 160. A nonlinear least-squares method is used as a method of calculating the coefficient c and the bias b.

If there are two or more characteristic formulas, restriction conditions are defined in order to maintain the characteristic formulas to be perpendicular to each other. The parameter adjuster 137 outputs, to the characteristic analysis sheet 184, the calculated coefficient c and the bias b with an upper limit value and a lower limit value of each variable, a model error, and so on. The parameter adjuster 137 may perform the parameter adjustment only when parameters of characteristic formulas need to be adjusted.

The model creator 140 obtains design information, such as the parameters (at least one of the coefficient c, the bias b, the upper limit value, and the lower limit value) and the characteristic formula, from the characteristic analysis sheet 184, and the model creator 140 creates a model of the plant 60. Since the obtained characteristic formula is defined for every cluster, the model creator 140 generates a piecewise linear approximate formula by unifying two or more characteristic formulas.

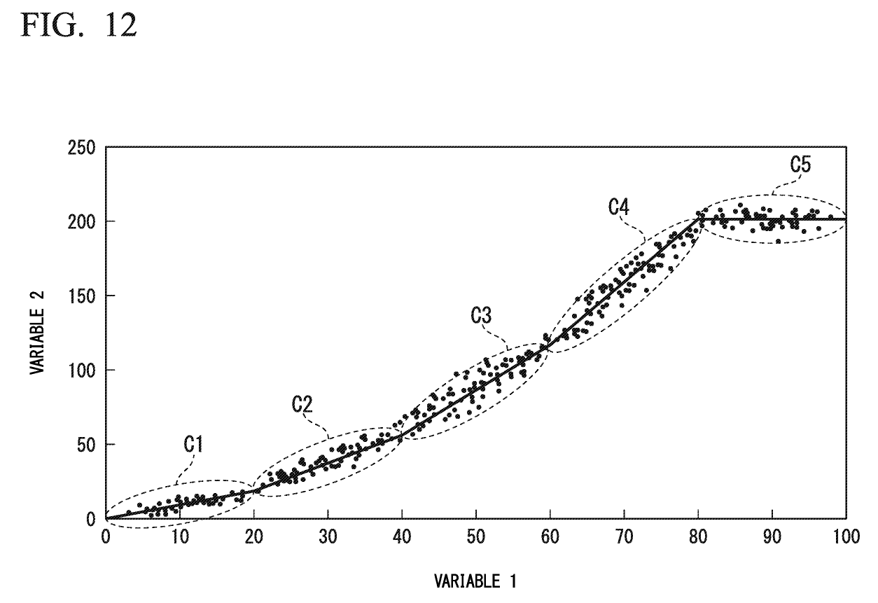

FIG. 12 is a drawing illustrating an example of the piecewise linear approximate formula generated by the model creator 140. In FIG. 12, the horizontal axis shows a variable 1 (for example, fuel amount) of the operating data 181, and the vertical axis shows a variable 2 (for example, power generation amount) of the operating data 181. In the example shown in FIG. 12, two variables are shown in order to understand easily, but the number of variables may be three or more.

As shown in FIG. 12, the model creator 140 unifies the characteristic formulas of the clusters C1 to C5, and generates a piecewise linear approximate formula. The model creator 140 stores, into the storage 160, the generated piecewise linear approximate formula as plant model information 192. Thereby, the model creator 140 can create an accurate model of the plant (plant model information 192).

The model creator 140 generates the input/output sheet 191 which is used for setting parameters and outputting an optimal solution, and the model creator 140 stores the generated input/output sheet 191 into the storage 160. The input/output sheet 191 is a sheet generated by using general spreadsheet software (for example, Microsoft Excel (registered trademark)).

The operation plan information generator 170 performs an optimization calculation based on instructions of the user from the interface 110. Specifically, the operation plan information generator 170 reads the energy flow diagram 193 and the plant model information 192 out of the storage 160. Thereafter, the operation plan information generator 170 compiles an executable file by using the energy flow diagram 193 and the plant model information 192 which have been read out of the storage 160. The operation plan information generator 170 reads the input/output sheet 191 out of the storage 160. Thereafter, the operation plan information generator 170 obtains parameters from the read input/output sheet 191, and creates a file.

Thereafter, the operation plan information generator 170 performs an optimization calculation. In the present embodiment, the operation plan information generator 170 can select either a rigorous solution method (Mixed Integer Linear Programming: MILP) or a high-speed approximate solution method (high-speed optimization method: HMPO) as an optimization method. The high-speed approximate solution method is an optimization method developed by the applicant (Japanese Unexamined Patent Application Publication No. 2015-62102: an operation plan creating method and an operation plan creating system).

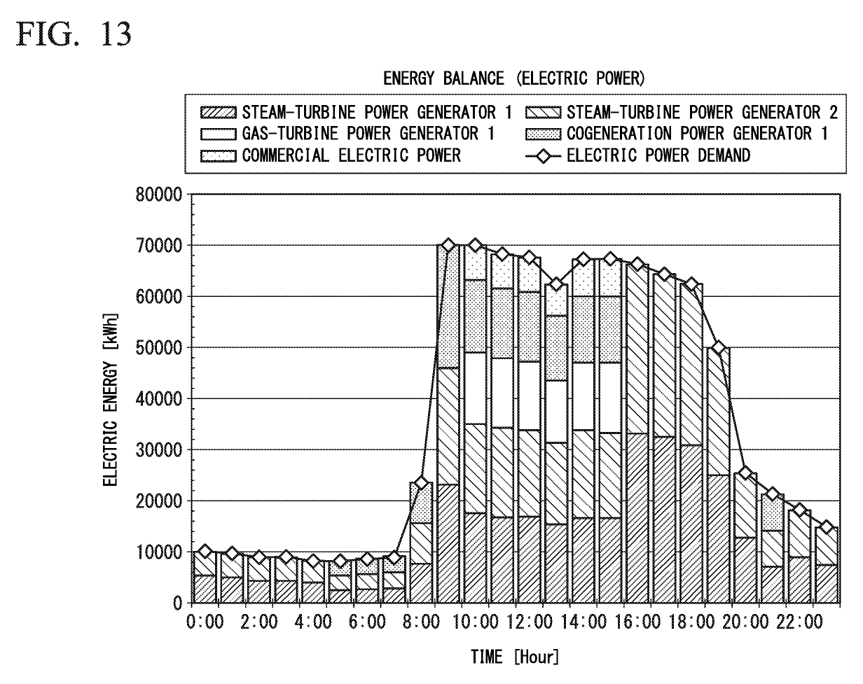

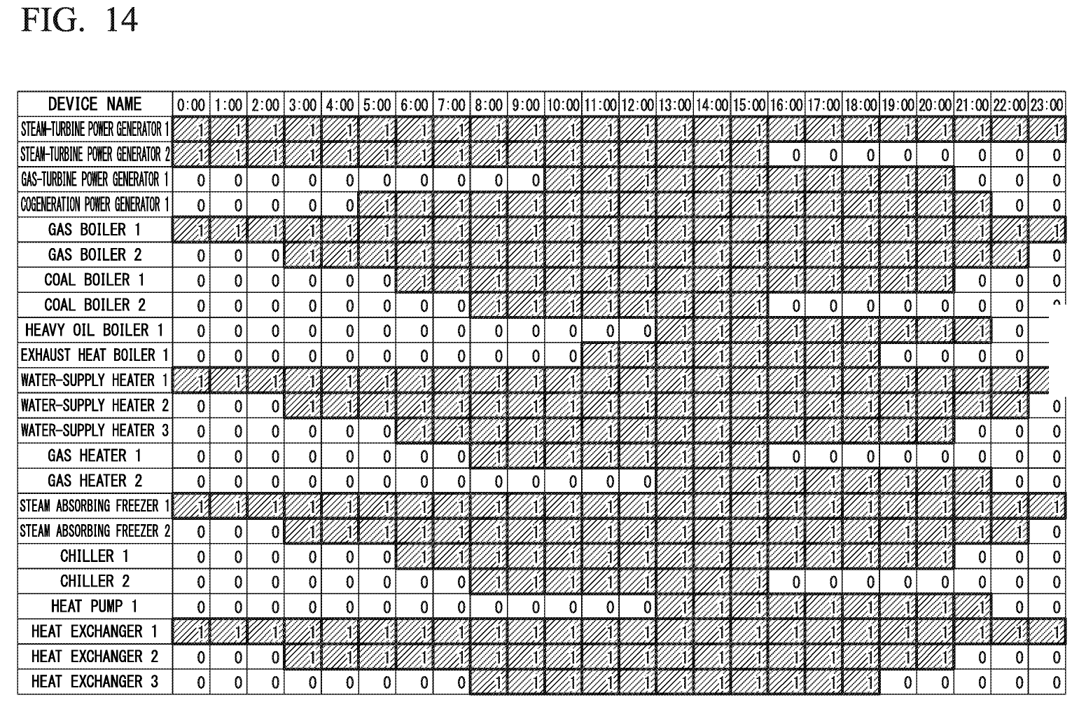

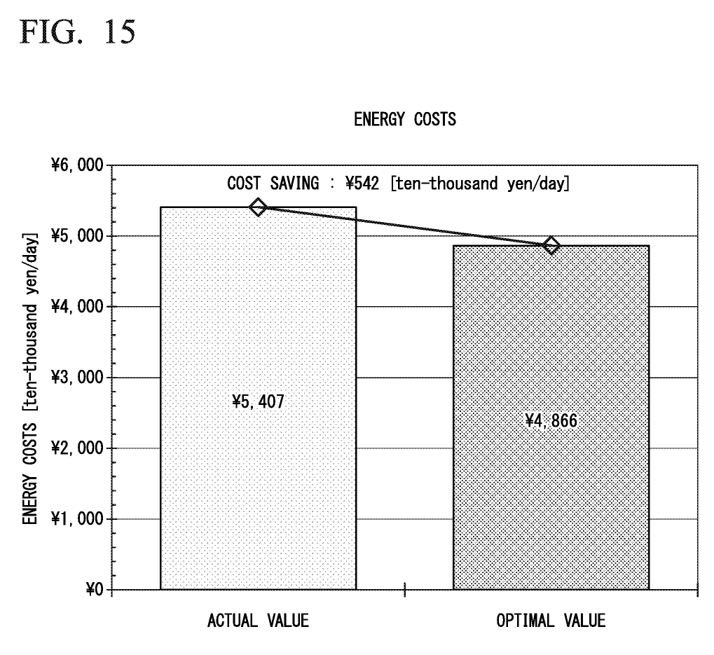

The operation plan information generator 170 executes the optimization calculation, and generates operation plan information including time series trend of input/output amount of equipment (FIG. 13), Gantt chart of operation showing start/stop of equipment (FIG. 14), and a cost-saving merit (FIG. 15). The operation plan information generator 170 transmits, to the plant information system 20, the generated operation plan information (the time series trend of input/output amount of equipment, the Gantt chart of operation, the cost-saving merit, and so on). Moreover, the operation plan information generator 170 outputs the generated operation plan information to the input/output sheet 191. The operation plan information generator 170 may generate an energy-saving merit with the cost-saving merit.

By performing the above-described processing, a model of the plant 60 can be created automatically. Thereby, the plant model creating device 100 can comprehensively extract characteristic formulas and restriction conditions related to equipment based on operating data of the plant, and the plant model creating device 100 can accurately create a model of the plant by a small number of man-hours without special knowledge.

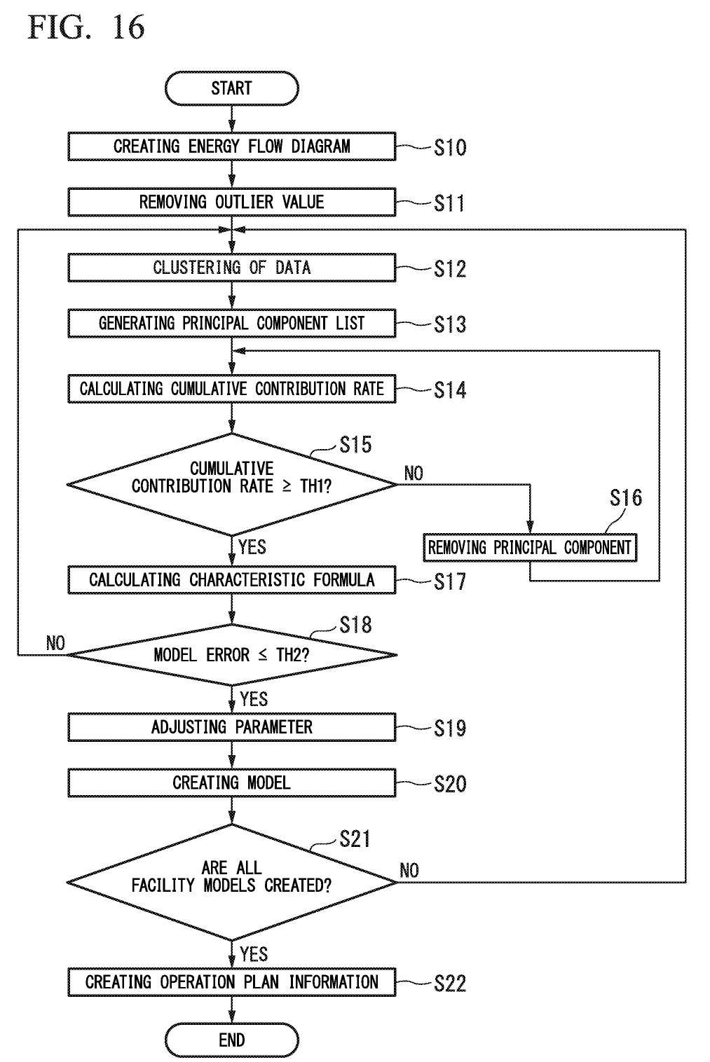

FIG. 16 is a flow chart showing an operation plan creation processing executed by the operation plan creating system 10. First, the energy flow diagram creator 150 creates an energy flow diagram 193 shown in FIG. 5 by using the operating data 181 of the plant 60 obtained by the operating data obtainer 120 (Step S10). Next, if a user instructs execution of “model creation” from the interface 110, creation processing (Step S11 to Step S21) of a plant model is started.

The outlier remover 131 removes outliers from the operating data 181 of the plant 60 by using Mahalanobis distance (Step S11). The cluster analyzer 132 clusters the operating data 181 (Step S12). Specifically, the cluster analyzer 132 generates clustering information 182 by dividing the operating data 181, from which outliers have been removed, into clusters by fitting based on a Gaussian Mixture Model.

The principal component list generator 133 calculates data including a principal component and a contribution rate CR for every cluster based on the clustering information 182 generated by the cluster analyzer 132. The principal component list generator 133 generates a principal component list 183 including the calculated data (Step S13). The cumulative contribution rate calculator 134 calculates a cumulative contribution rate CCR based on the principal component list 183 generated by the principal component list generator 133 (Step S14).

The principal component remover 135 determines whether the cumulative contribution rate CCR calculated by the cumulative contribution rate calculator 134 is less than the first threshold value TH1 or not (Step S15). If the cumulative contribution rate CCR is less than the first threshold value TH1 (Step S15: NO), the principal component remover 135 removes, from the principal component list 183, the principal component corresponding to the contribution rate CR added to the cumulative contribution rate CCR (Step S16), and the processing returns to the above-described Step S14.

If the cumulative contribution rate CCR is more than or equal to the first threshold value TH1 (Step S15: YES), the characteristic formula calculator 136 calculates a characteristic formula whose normal vector is the principal component included in the principal component list 183, and the characteristic formula calculator 136 outputs the calculated characteristic formula to the characteristic analysis sheet 184 (Step S17).

The operation characteristics analyzer 130 determines whether a model error representing an error between an estimate value (model value) of each variable calculated based on the characteristic formula and the operating data 181 is less than or equal to the second threshold value TH2 or not (Step S18). If the model error is larger than the second threshold value TH2 (Step S18: NO), the processing returns to the above-described Step S12.

If the model error is less than or equal to the second threshold value TH2 (Step S18: YES), the parameter adjuster 137 adjusts parameters included in the characteristic formulas calculated by the characteristic formula calculator 136, and the parameter adjuster 137 outputs, to the characteristic analysis sheet 184, the characteristic formula whose parameters have been adjusted (Step S19). The model creator 140 creates plant model information 192 representing a model of the plant 60 based on the characteristic formulas which have been output to the characteristic analysis sheet 184 (Step S20).

The operation characteristics analyzer 130 determines whether the plant model information 192 of all the equipment of the plant 60 has been created or not (Step S21). If the plant model information 192 of all the equipment of the plant 60 has not been created (Step S21: NO), the processing returns to the above-described Step S12. If the plant model information 192 of all the equipment of the plant 60 has been created (Step S21: YES), the operation plan information generator 170 generates operation plan information (at least one of the time series trend of input/output amount of equipment, the Gantt chart of operation, the cost-saving merit, and so on) by using the energy flow diagram 193 created by the energy flow diagram creator 150 and the plant model information 192 created by the model creator 140 (Step S22), and the processing of this flow chart is ended.

The plant model creating device 100 in the above-described embodiment is equipped with a computer system. The procedures of processing performed by the plant model creating device 100 shown in FIG. 16 are stored in a non-transitory computer readable storage medium in a form of one or more programs, and various types of processing are executed by a computer by reading and executing this program. Here, the non-transitory computer readable storage medium is such as a magnetic disk, a magneto-optical disk, a CD-ROM, a DVD-ROM, a semiconductor memory, and so on. This program may be distributed to the computer through a communication line, and the computer which has received the program may execute the program.

As described above, the plant model creating device 100 includes the outlier remover 131, the cluster analyzer 132, the principal component list generator 133, the cumulative contribution rate calculator 134, the principal component remover 135, the characteristic formula calculator 136, and the model creator 140. The outlier remover 131 removes outliers from operating data 181 of a plant. The cluster analyzer 132 divides, into clusters, the operating data 181 from which the outliers have been removed. The principal component list generator 133 calculates a principal component and a contribution rate for every cluster. The principal component list generator 133 generates a principal component list 183 including the principal component and the contribution rate. The cumulative contribution rate calculator 134 calculates a cumulative contribution rate based on the principal component list. The principal component remover 135 removes, from the principal component list 183, a principal component corresponding to a contribution rate added to the cumulative contribution rate, if the cumulative contribution rate is less than a first threshold value TH1. The characteristic formula calculator 136 calculates a characteristic formula whose normal vector is the principal component included in the principal component list 183. The model creator 140 creates plant model information 192 based on the calculated characteristic formula. Thereby, the plant model creating device 100 can comprehensively extract characteristic formulas and restriction conditions related to equipment based on operating data of the plant, and the plant model creating device 100 can accurately create a model of the plant 60 by a small number of man-hours without special knowledge.

As used herein, the following directional terms “front, back, above, downward, right, left, vertical, horizontal, below, transverse, row and column” as well as any other similar directional terms refer to those instructions of a device equipped with the present invention. Accordingly, these terms, as utilized to describe the present invention should be interpreted relative to a device equipped with the present invention.

The term “configured” is used to describe a component, unit or part of a device includes hardware and/or software that is constructed and/or programmed to carry out the desired function.

Moreover, terms that are expressed as “means-plus function” in the claims should include any structure that can be utilized to carry out the function of that part of the present invention.

The term “unit” is used to describe a component, unit or part of a hardware and/or software that is constructed and/or programmed to carry out the desired function. Typical examples of the hardware may include, but are not limited to, a device and a circuit.

While preferred embodiments of the present invention have been described and illustrated above, it should be understood that these are examples of the present invention and are not to be considered as limiting. Additions, omissions, substitutions, and other modifications can be made without departing from the scope of the present invention. Accordingly, the present invention is not to be considered as being limited by the foregoing description, and is only limited by the scope of the claims.

What is claimed is:

1. A plant model creating device comprising:
an outlier remover configured to remove outliers from operating data of a plant;
a cluster analyzer configured to divide, into clusters, the operating data from which the outliers have been removed by the outlier remover;
a principal component list generator configured to calculate a principal component and a contribution rate for each of the clusters divided by the cluster analyzer, the principal component list generator being configured to generate a principal component list including the principal component and the contribution rate;
a cumulative contribution rate calculator configured to calculate a cumulative contribution rate based on the principal component list generated by the principal component list generator;
a principal component remover configured to remove, from the principal component list, a principal component corresponding to a contribution rate added to the cumulative contribution rate, if the cumulative contribution rate calculated by the cumulative contribution rate calculator is less than a first threshold value;
a characteristic formula calculator configured to calculate a characteristic formula whose normal vector represents the principal component included in the principal component list; and
a model creator configured to create a model of the plant based on the characteristic formula calculated by the characteristic formula calculator.

2. The plant model creating device according to claim 1, further comprising:
a parameter adjuster configured to adjust parameters included in the characteristic formula calculated by the characteristic formula calculator,
wherein the model creator is configured to create the model of the plant based on the characteristic formula whose parameters has been adjusted by the parameter adjuster.

3. The plant model creating device according to claim 2,
wherein the parameter adjuster is configured to adjust at least one of a coefficient and a bias which are included in the characteristic formula, and an upper limit value and a lower limit value of a variable included in the operating data.

4. The plant model creating device according to claim 1, further comprising:
an energy flow diagram creator configured to create an energy flow diagram by using the operating data of the plant; and
an operation plan information generator configured to generate operation plan information by using the energy flow diagram created by the energy flow diagram creator and the model created by the model creator.

5. The plant model creating device according to claim 4,
wherein the operation plan information generator is configured to generate, as the operation plan information, at least one of time series trend of input/output amount of equipment installed in the plant, Gantt chart of operation showing start/stop of the equipment, and a cost-saving merit.

6. The plant model creating device according to claim 1,
wherein if an error between an estimate value of the operating data calculated based on the characteristic formula and an actual measurement value of the operating data is greater than a second threshold, the cluster analyzer increases a division number of the operating data and divides the operating data into clusters again.

7. The plant model creating device according to claim 1,
wherein the model creator is configured to generate, as the model of the plant, a piecewise linear approximate formula by unifying two or more characteristic formulas calculated by the characteristic formula calculator.

8. A plant model creating method comprising:
removing outliers from operating data of a plant;
dividing, into clusters, the operating data from which the outliers have been removed;
calculating a principal component and a contribution rate for every cluster;
generating a principal component list including the principal component and the contribution rate;
calculating a cumulative contribution rate based on the principal component list;
removing, from the principal component list, a principal component corresponding to a contribution rate added to the cumulative contribution rate, if the cumulative contribution rate is less than a first threshold value;
calculating a characteristic formula whose normal vector is the principal component included in the principal component list; and
creating a model of the plant based on the characteristic formula.

9. The plant model creating method according to claim 8, further comprising:
adjusting parameters included in the characteristic formula; and
creating the model of the plant based on the characteristic formula whose parameters has been adjusted.

10. The plant model creating method according to claim 9, further comprising:
adjusting at least one of a coefficient and a bias which are included in the characteristic formula, and an upper limit value and a lower limit value of a variable included in the operating data.

11. The plant model creating method according to claim 8, further comprising:
creating an energy flow diagram by using the operating data of the plant; and
generating operation plan information by using the energy flow diagram and the model.

12. The plant model creating method according to claim 11, further comprising:
generating, as the operation plan information, at least one of time series trend of input/output amount of equipment installed in the plant, Gantt chart of operation showing start/stop of the equipment, and a cost-saving merit.

13. The plant model creating method according to claim 8, further comprising:
if an error between an estimate value of the operating data calculated based on the characteristic formula and an actual measurement value of the operating data is greater than a second threshold,
increasing a division number of the operating data; and
dividing the operating data into clusters again.

14. The plant model creating method according to claim 8, further comprising:
generating, as the model of the plant, a piecewise linear approximate formula by unifying two or more characteristic formulas.

15. A non-transitory computer readable storage medium storing one or more plant model creating programs configured for execution by a computer, the one or more programs comprising instructions for:
removing outliers from operating data of a plant;
dividing, into clusters, the operating data from which the outliers have been removed;
calculating a principal component and a contribution rate for every cluster;
generating a principal component list including the principal component and the contribution rate;
calculating a cumulative contribution rate based on the principal component list;
removing, from the principal component list, a principal component corresponding to a contribution rate added to the cumulative contribution rate, if the cumulative contribution rate is less than a first threshold value;
calculating a characteristic formula whose normal vector is the principal component included in the principal component list; and
creating a model of the plant based on the characteristic formula.

16. The computer readable storage medium according to claim 15, wherein the one or more plant model creating programs comprise instructions for:
adjusting parameters included in the characteristic formula; and
creating the model of the plant based on the characteristic formula whose parameters has been adjusted.

17. The computer readable storage medium according to claim 16, wherein the one or more plant model creating programs comprise instructions for:
adjusting at least one of a coefficient and a bias which are included in the characteristic formula, and an upper limit value and a lower limit value of a variable included in the operating data.

18. The computer readable storage medium according to claim 15, wherein the one or more plant model creating programs comprise instructions for:
creating an energy flow diagram by using the operating data of the plant; and
generating operation plan information by using the energy flow diagram and the model.

19. The computer readable storage medium according to claim 18, wherein the one or more plant model creating programs comprise instructions for:
generating, as the operation plan information, at least one of time series trend of input/output amount of equipment installed in the plant, Gantt chart of operation showing start/stop of the equipment, and a cost-saving merit.

20. The computer readable storage medium according to claim 15, wherein the one or more plant model creating programs comprise instructions for:
if an error between an estimate value of the operating data calculated based on the characteristic formula and an actual measurement value of the operating data is greater than a second threshold,
increasing a division number of the operating data; and
dividing the operating data into clusters again.
